(19) United States
(12) Patent Application Publication
(10) Pub. No.: US 2026/0208636 A1
(43) Pub. Date: Jul. 23, 2026

(54) CHILD SEAT WITH LAY FLAT FUNCTION

(71) Applicant: Britax Child Safety, Inc., Fort Mill, SC (US)

(72) Inventor: Michael Fürstenberg, Fort Mill, SC (US)

(21) Appl. No.: 19/425,107

(22) Filed: Dec. 18, 2025

Related U.S. Application Data
(60) Provisional application No. 63/747,688, filed on Jan. 21, 2025.

(51) Int. Cl. B60N 2/28

(52) U.S. Cl. CPC B60N 2/2893; B60N 2/2806; B60N 2/2878

(57) ABSTRACT

A child seat configured to be secured to a base secured to a car seat is provided. The child seat includes backrest and a lower seat shell pivotably coupled to a base. The lower seat shell can be rotated between a front facing, side facing and a rear facing direction. The backrest of the child seat can also recline at a variety of angles and may further include a blocker adjustable between an activated position and a not activated position. The blocker may prevent the backrest of the child seat from reclining.

### PRIORITY CLAIM AND CROSS-REFERENCE TO RELATED APPLICATION

The present application claims priority to and the benefit of U.S. Provisional Patent Application No. 63/747,688 filed January 21, 2025, which is incorporated herein by reference in its entirety and relied upon.

### BACKGROUND

Child restraint systems, also commonly called child safety seats, child seats, car seats, or booster seats, among others, are designed to protect children in vehicles from the effects of impacts or sudden changes in motion (e.g., sudden acceleration, sudden deceleration, and the like). Child restraint systems, referred to hereinafter as child seats, may be used in a variety of vehicles with different seat types and/or seating configurations. It is important for a child seat to be properly secured to the vehicle (e.g., car) seat to protect the occupant and it is important for the occupant to be properly and comfortably secured in the child seat. Child safety seats are typically placed on a standard car seat and secured in position either with dedicated devices including ISOFIX connectors (i.e., ISOFIX arms), foot props, top tethers or with the vehicle's seat belt for that seat. Often a combination of the afore-mentioned devices is used to secure the safety seat to the vehicle. Some child seats are secured to a car seat with a seat belt of the car; however, securing the child seat may be awkward and difficult to maintain a proper amount of tension. Further, a user may be required to secure the child seat to a vehicle seat with limited space, making it difficult to maneuver the child seat to assure proper securement. Moreover, some child seats lack the ability to be manipulated into a variety of positions. This can be costly for consumers as children could rapidly outgrow their child seat and frequently need a new one. Thus, a child seat with the ability to accommodate a variety of ages and sizes is desirable.

Accordingly, there is a need for child seats with a lay flat function that allow for both rotation and reclining at a variety of angles.

### SUMMARY

The present disclosure relates to child restraint systems and, more particularly, to child restraint systems that allow for both rotation and reclining at a variety of angles.

Aspects of the subject matter described herein may be useful alone or in combination with one or more other aspects described herein. In an exemplary aspect of the present disclosure, a child seat system is configured to be secured to a car seat. The system includes child seat and a base. The child seat comprises a backrest and a lower seat shell, wherein the backrest can recline relative to a pivot point between an upright position, a lay flat position, and one or more in between positions. The base is configured to receive the lower seat shell. The system further includes a blocker wherein the blocker is adjustable between an activated position and a not activated position, wherein, in the activated position, the blocker prevents the backrest from reclining, and wherein, in the not activated position, the backrest is adjustable between the first position and the second position.

In a second aspect of the present disclosure, which may be combined with any other aspect listed herein unless specified otherwise, the base includes a base-frame, ISOFIX arms connected to the base-frame, and a ring positioned at an angle relative to the base-frame.

In a third aspect of the present disclosure, which may be combined with any other aspect listed herein unless specified otherwise, the ring includes an outer ring and an inner ring.

In a fourth aspect of the present disclosure, which may be combined with any other aspect listed herein unless specified otherwise, the outer ring includes at least one notch.

In a fifth aspect of the present disclosure, which may be combined with any other aspect listed herein unless specified otherwise, the lower seat shell includes at least one protrusion wherein the at least one protrusion is configured to engage the at least one notch when the child seat is in a side facing direction.

In a sixth aspect of the present disclosure, which may be combined with any other aspect listed herein unless specified otherwise, the child seat system includes a rebound bar and the ring is connected to the base-frame and the rebound bar.

In a seventh aspect of the present disclosure, which may be combined with any other aspect listed herein unless specified otherwise, the rebound bar is connected to the ring and the base-frame.

In an eighth aspect of the present disclosure, which may be combined with any other aspect listed herein unless specified otherwise, the base includes a first bar positioned between the ring and the rebound bar, and a second bar positioned between the ring and the base-frame.

In a ninth aspect of the present disclosure, which may be combined with any other aspect listed herein unless specified otherwise, the pivot point is located inside the base.

In a tenth aspect of the present disclosure, which may be combined with any other aspect listed herein unless specified otherwise, the base is configured to receive the seat belt, and the base is fixed to the car seat.

In an eleventh aspect of the present disclosure, which may be combined with any other aspect listed herein unless specified otherwise, the angle is 13 degrees.

In a twelfth aspect of the present disclosure, which may be combined with any other aspect listed herein unless specified otherwise, the blocker includes a handle fixedly coupled to an insert located on the backrest, and a volume located on the lower seat shell. The volume is configured to receive the insert.

In a thirteenth aspect of the present disclosure, which may be combined with any other aspect listed herein unless specified otherwise, the blocker is in the activated position when the insert is engaged with the volume and wherein the blocker is in the not activated position when the insert is disengaged from the volume.

In a fourteenth aspect of the present disclosure, which may be combined with any other aspect listed herein unless specified otherwise, the volume is a plurality of pockets.

In a fifteenth aspect of the present disclosure, which may be combined with any other aspect listed herein unless specified otherwise, a child seat configured to be secured to a child seat includes a backrest and a lower seat shell. The backrest can recline relative to a pivot point between an upright position, a lay flat position, and one or more in between positions. A blocker is adjustable between an activated position and a not activated position. In the activated position, the blocker prevents the backrest from reclining. In the not activated position, the backrest is adjustable between the first position and the second position.

In a sixteenth aspect of the present disclosure, which may be combined with any other aspect listed herein unless specified otherwise, the lower seat shell comprises a at least one protrusion.

In a seventeenth aspect of the present disclosure, which may be combined with any other aspect listed herein unless specified otherwise, a method of securing a child seat to a car seat includes placing the child seat of Claim 16 onto a base.

In an eighteenth aspect of the present disclosure, which may be combined with any other aspect listed herein unless specified otherwise, the base includes a base-frame, ISOFIX arms, a ring, and a rebound bar.

In a nineteenth aspect of the present disclosure, which may be combined with any other aspect listed herein unless specified otherwise, the ring includes an outer ring with at least one notch and an inner ring. The at least one protrusion is configured to engage the at least one notch.

In a twentieth aspect of the present disclosure, which may be combined with any other aspect listed herein unless specified otherwise, the method includes aligning the least one protrusion with the at least one notch when the child seat is in a side facing direction and twisting the child seat to a front facing or a rear facing direction.

In a twenty-first aspect of the present disclosure, any of the structure, functionality, and alternatives disclosed in connection with any one or more of FIGS. 1 to 13 may be combined with any other structure, functionality, and alternatives disclosed in connection with any other one or more of FIGS. 1 to 13.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE FIGURES

The specification makes reference to the following figures, in which use of like reference numerals in different figures is intended to illustrate like or analogous components.

FIG. 1 illustrates a front perspective view of an example child seat in a front facing direction and an upright position, according to an example embodiment of the present disclosure;

FIG. 2 illustrates a front perspective view of an example child seat in a side facing direction and an upright position, according to an example embodiment of the present disclosure;

FIG. 3 illustrates a front perspective view of an example child seat in a rear facing direction and an upright position, according to an example embodiment of the present disclosure;

FIG. 4 illustrates a top perspective view of a base of a child seat disclosed in FIGS. 1 to 3, according to an example embodiment of the present disclosure;

FIG. 5 illustrates a top view of a base of a child seat disclosed in FIGS. 1 to 3, according to an example embodiment of the present disclosure;

FIG. 6 illustrates a side view of a base of a child seat disclosed in FIGS. 1 to 3, according to an example embodiment of the present disclosure;

FIG. 7 illustrates a rear perspective view of a base of a child seat disclosed in FIGS. 1 to 3, according to an example embodiment of the present disclosure;

FIG. 8 illustrates a side view of an example child seat in a front facing direction and an upright position, according to an example embodiment of the present disclosure;

FIG. 9 illustrates a rear perspective view of an example child seat in a front facing direction and an upright position, according to an example embodiment of the present disclosure;

FIG. 10 illustrates a side perspective view of an example child seat in a front facing direction, an upright position and a blocker in a not activated arrangement, according to an example embodiment of the present disclosure;

FIG. 11 illustrates a side perspective view of an example child seat in a front facing direction, an upright position and a blocker in an activated arrangement, according to an example embodiment of the present disclosure;

FIG. 12 illustrates a side perspective view of an example child seat in a rear facing direction, an upright position and a blocker in an activated arrangement, according to an example embodiment of the present disclosure; and

FIG. 13 illustrates a side perspective view of an example child seat in a rear facing direction, a lay flat position and a blocker in an activated arrangement, according to an example embodiment of the present disclosure.

### DETAILED DESCRIPTION

Systems, methods, and apparatus are disclosed herein for a child seat with a lay flat function. Example embodiments will now be described more fully with reference to the accompanying drawings

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or additional of one or more other features, integers, steps, operations, elements, components, and/or groups thereof.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A child seat may be configured for installation based on the height and weight of a child and according to various guidelines and standards, such as those of the United States National Highway Transportation Safety Administration. To ensure maximum protection for an occupant of the child seat, the child seat must be secured to a fixed location in a vehicle, such as using a seat belt of the car seat or Lower Anchors and Tethers for Children (“LATCH”) or ISOFIX attachments. When seat belts are used to secure the child seat, the seat belt is often positioned around the child seat and then engaged with a buckle attached to the car seat. However, slack in the seat belt may often occur, even when the seat belt is tightly fastened, and such slack causes the child seat to be loosely secured to the vehicle, which presents an unsafe condition for the occupant of the child seat. Moreover, a user is often required to install the child seat in a vehicle with limited space, making it difficult to maneuver the child seat and properly position a seat belt around the child seat. With additional space, the chances of proper installment may increase, providing safer conditions for the occupant of the child seat during transport.

Described herein is a child seat 100 which can include mechanisms for both rotation and reclining. In certain aspects, the child seat 100 described herein may allow a user to rotate the child seat 100 to a front facing direction, a side facing direction or a rear facing direction. Further, the child seat 100 can recline between an upright position, a lay flat position and one or more in between positions. The child seat 100 also includes a blocker 114, which can be activated or not activated. The blocker 114, when activated, restricts the user from reclining the child seat 100. In certain example embodiments, the child seat 100 includes a base 106, which secures the child seat 100 to the car seat. This increases safety for occupants of the child seat 100. In this regard, the base 106 retains the seat belt and is stationary to the vehicle seat the child seat 100 despite what rotational direction or reclined position the child seat 100 is in. As described herein, the child seat 100 can be detachable from the base 106. It should be appreciated, however, that in alternate embodiment the child seat 100 can be firmly affixed to, and thus not detachable from, the base 106. Various other advantages and benefits may be realized as described herein, and the aforementioned benefits and advantages should not be considered limiting.

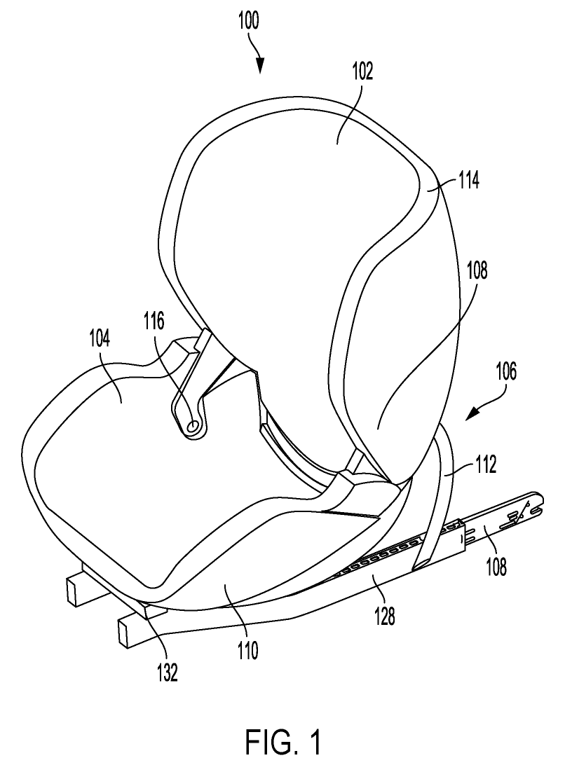

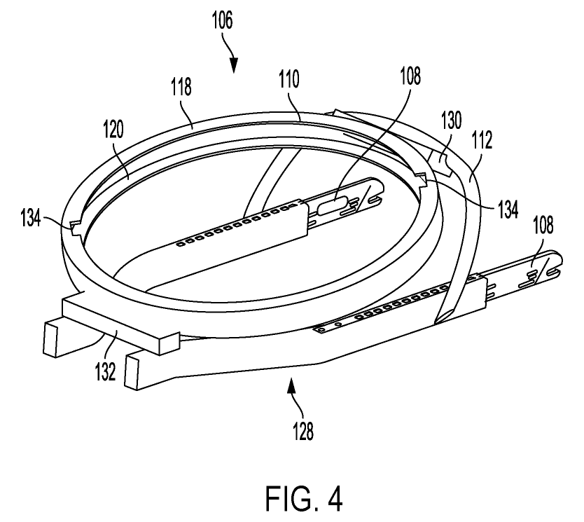

FIG. 1 illustrates a front perspective view of an example child seat 100 in a front facing direction and an upright position. In the illustrated embodiment, the child seat 100 is a toddler child seat in a front facing direction. However, the child seat 100 can be any kind of seat for infants, toddlers, or children. The child seat 100 includes a backrest 102, a lower seat shell 104 and a base 106 (disclosed in further detail in FIGS. 4 to 6). The base 106 comprises a base-frame 128, a ring 110 and a rebound bar 112, which are fixed. In certain embodiments, the rebound bar 112 is optional, as the base 106 is operable without the rebound bar 112. It should be appreciated, however, that in certain example embodiments the rebound bar 112 is included, as rebound bar 112 provides extra stability and support. The base-frame 128 comprises ISOFIX arms 108. In this regard, the base 106 is configured to be secured to the vehicle (e.g., car) seat. The base 106 can also be installed in belted mode (e.g., with the vehicle seat belt). The ring 110 of the base 106 is configured to accept the lower seat shell 104 such that when the lower seat shell 104 is placed onto the ring 110, the lower seat shell 104 is secured to the base 106. Once secured to the base 106, the child seat 100 can be configured to rotate in relation to the ring 110. However, the child seat 100, which can recline between an upright position, a lay flat position and one or more in between positions can also be applied to a child seat 100 that is not rotatable. Thus, the child seat 100 can be rotatable, not rotatable and front facing, not rotatable and rear facing, or rotatable but only usable in one direction.

If the child seat 100 is configured to rotate in relation to the ring 100, the user may rotate the child seat 100 in a variety of directions. For example, the user may rotate the child seat 100 to a rear facing direction. The user may also rotate the child seat 100 to a side facing direction. The side facing direction provides ease of access for the user to load or unload an occupant into the child seat 100. In certain embodiments, once the occupant is secured to the child seat 100, the user could then rotate the child seat 100 to the front facing direction or the rear facing direction during transport. Notably, the child seat 100 is configured to lock relative to the ring 100, such that users can selectively hold the child seat 100 at a given position.

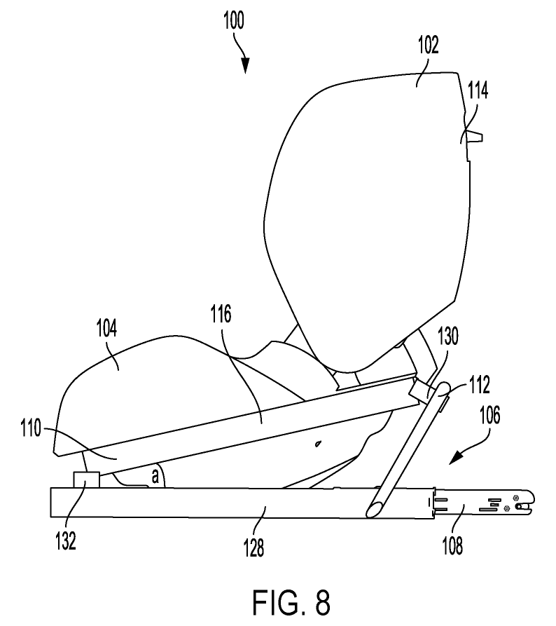

The backrest 102 of the child seat 100 is configured to recline in relation to the lower seat shell 104. Thus, the child seat 100 also includes a blocker 114 (shown in FIG. 8), which allows the user to lock or restriction the backrest 102 at its reclined position. The blocker 114 can be activated or not activated. In the activated arrangement, blocker 114 does not allow the backrest 102 to recline in relation to the lower seat shell 104 of the child seat 100. In the not activated arrangement, the backrest 102 of the child seat 100 may be adjusted to a preferred angle relative to the lower seat shell 104. As an illustrative example, once the user adjusts the backrest 102 to a preferred angle relative to the lower seat shell 104, the user can activate the blocker 114 such that the backrest 102 will not move from the preferred angle. The backrest 102 of the child seat 100 can be reclined to a variety of positions, which include an upright position, a lay flat position and one or more in between positions. The one or more in between positions refer to any angle between the upright and lay flat positions.

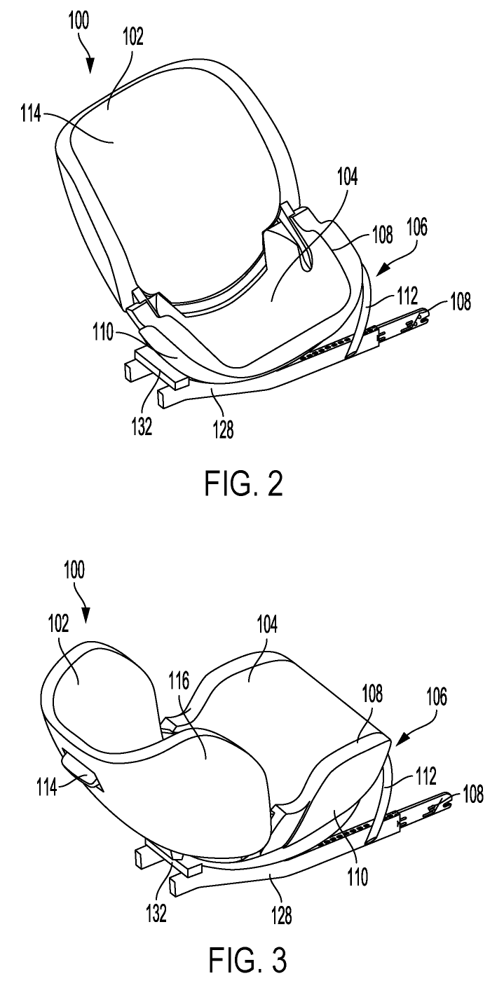

FIG. 2 illustrates a front perspective view of the child seat 100 in a side facing direction and an upright position. In the side facing direction, the user will be able to easily place and secure the occupant in the child seat 100 before rotating the child seat 100 to the front facing or rear facing direction. This rotation step occurs in relation to the ring 110 of the base 106. FIG. 3 illustrates a front perspective view of the child seat 100 in a rear facing configuration in an upright position. In the rear facing configuration, the occupant of the child seat 100 will be facing the back of the vehicle (e.g., car). The rear facing configuration is preferable for infants or small toddlers.

Next, FIG. 4 illustrates a top perspective view of the base 106 of a child seat 100 as disclosed in FIGS. 1 to 3. As introduced in reference to FIG. 1, the base 106 includes a base-frame 128, a ring 110, a rebound bar 112, and a blocker 114. The base-frame further comprises ISOFIX arms 108, for selectively coupling the base 106 to a vehicle seat. The ISOFIX arms 108 reduce the need for the user to continuously adjust the seatbelt subject to the direction and position of the child seat 100. Further, if the base 106 is able to remain stationary to the vehicle seat, the removal and installation of the child seat 100 is easier as opposed to requiring removal and installation of the entire child seat including the base.

However, other example embodiments include a child seat 100 fixedly coupled to the base 106 such that the child seat 100 and the base 106 can be installed and removed together. Preferably, the components of the base 106 are static with respect to one another. For example, the rebound bar 112 is fixed to the base-frame 128. The ring 110 is fixed to the rebound bar 112 and the base-frame 128. The ring 110 is fixed at an angle relative to the base-frame 128. As an illustrative example, the angle of the ring 110 in relation to the base-frame 128 is 13 degrees. The angle of the ring is designed such that child seat 100 will fix inside the iso box standard despite the rotation position or recline angle the child seat 100 is positioned.

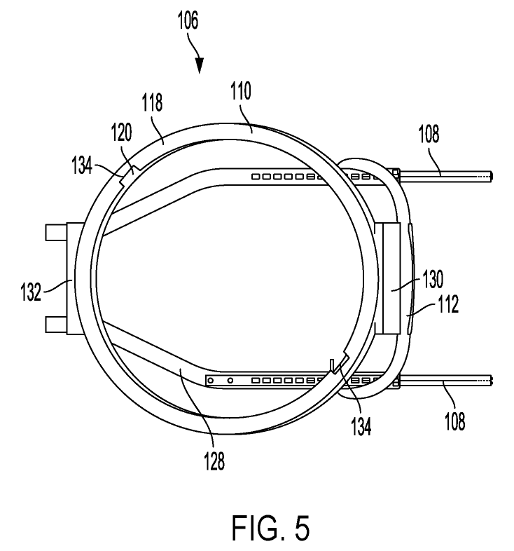

Relatedly, FIG. 5 illustrates a perspective view of the base 106 of child seat 100 disclosed in FIGS. 1 to 3. As previously noted, the base 106 includes a base-frame 128, a ring 110 and an optional rebound bar 112, which are static in relation to one another. As also noted, the base-frame 128 further comprises ISOFIX arms 108. The ring 110 further comprises includes an outer ring 118 and an inner ring 120. In relation to one another, the outer ring 118 is further from the base-frame 128 and the inner ring 120 sits closer to the base-frame 128. The purpose of the outer ring 118 and the inner ring 120 is to allow a lower seat shell 104 of the child seat 100 to be secured to the base 106 and allow the child seat 100 to rotate in relation to the ring 110. Once the lower seat shell 104 is inserted into the ring 110, the lower seat shell 104 of the child seat 100 can rotate.

In various embodiments, the base 106 is symmetric. For example, FIG. 5 illustrates a base 106 comprising a base-frame 128, a ring 110 and a rebound bar 112. The base-frame 128 further comprises ISOFIX arms 108. Further, to facilitate symmetry and stability, the base 106 can include a first bar 130, which connects the ring 110 and the rebound bar 112. Additionally, to facilitate symmetry and stability, the base 106 can include a second bar 132, which connects the ring 110 with the base-frame 128. The first bar 130 and the second bar 132 can be in a variety of shapes, for example, a rectangle. The edges of the first bar 130 and the second bar 132 can be straight, curved or a combination thereof. Preferably but not required, the first bar 130 and the second bar 132 include one curved edge such that the curved edge increases the surface area between the first bar 130 and the second bar 132 and the ring 110.

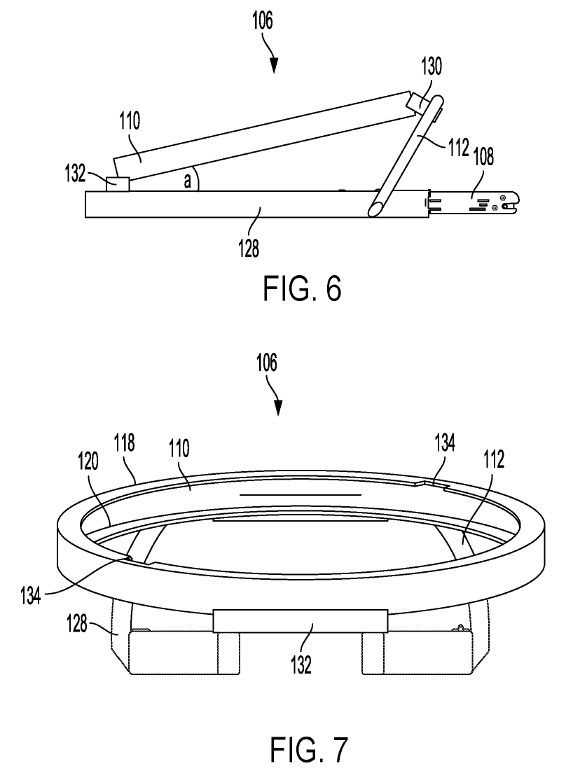

FIG. 6 illustrates a side perspective view of the base 106 of the child seat 100 disclosed in FIGS. 1 to 3. The base-frame 128 and the ISOFIX arms 108 are is designed to rest on the vehicle (e.g., car) seat. Connected to the base-frame 128 is the rebound bar 112 and the ring 110. The ring 110 and the rebound bar 112 are also connected. Preferably but not required, the base 106 can include a first bar 130 and a second bar 132, as previously noted. The first bar 130 increases the surface area for attachment between the ring 110 and the base-frame 128. Likewise, the second bar 132 increases the surface area for attachment between the ring 110 and the base-frame 128. The first bar 130 and the second bar 132 ensure the ring 110 is placed at the desired angle relative to the base 110. As disclosed above, the ring is placed at an angle relative to the base-frame 128, which is disclosed in FIG. 6 as angle a for illustrative purposes. Preferably, angle “a” is 13 degrees.

FIG. 7 illustrates a rear perspective view of the base 106 of the child seat 100 disclosed in FIGS. 1 to 3. The base 106 of the child seat 100 includes the base-frame 128, the ring 110 and the rebound bar 112. The base-frame comprises ISOFIX arms 108. As noted, the ring 110 comprises an outer ring 118 and an inner ring 120. The outer ring 118 in certain embodiments includes notches 134, which allow for the lower seat shell 104 of the child seat 100 to secure inside the ring 110. If the outer ring 118 includes notches 134, the notches 134 will correspond to protrusions (not disclosed) on the lower seat shell 104 of the child seat 100. As an illustrative example, if the outer ring 118 of the ring 110 includes two notches 126, the lower seat shell 104 of the child seat 100 will include two protrusions. Thus, to secure the child seat 100 to the ring 110, the user will place the child seat 100 on the base 106 and align the notches 126 of the outer ring 118 with the protrusions of the lower seat shell 104. Next, the notches 134 cause the protrusions of the lower seat shell 104 to fall through the outer ring 118 and settle on the inner ring 120. Once the protrusions are settled on the inner ring 120, the child seat 100 is free to rotate relative to the ring. If the child seat 100 is rotated to a front facing or rear facing direction such that the notches 134 of the outer ring 118 are not aligned with the protrusions of the lower seat shell 104, the child seat 100 will be secured to the ring 110. When a user wants to remove the child seat 100 from the base 106, the user can rotate the lower seat shell 104 of the base 106 such that the protrusions of the lower seat shell 104 align with the position of the notches 134 of the outer ring 118. When aligned, the user can lift the child seat 100 upwards and the notches 134 of the outer ring 118 will allow the protrusions of the lower seat shell 104 to fit through the outer ring 118 of the ring 110.

FIG. 8 illustrates a side perspective view of the child seat 100 in a front facing direction and an upright position. The child seat 100 includes a backrest 102 and a lower seat shell 104. Also disclosed is a base 106, which includes a base-frame 128, a ring 110 and a rebound bar 112. The base-frame 128 further comprises ISOFIX arms 108. The base 106 is stationary to the vehicle (e.g., car) seat. As disclosed, the lower seat shell 104 of the child seat 100 is configured to attach to the ring 110.

It should also be appreciated that the backrest 102 of the child seat 100 includes a blocker 114, which retains the backrest 102 at a variety of fixed recline angles in relation to the base-frame 128. In this regard, the blocker 114 allows the backrest 102 of the child seat 100 to recline at a variety of angles including an upright position, a lay flat position and one or more in between positions. For example, in a front facing direction, the upright angle corresponds to 105 degrees from the base-frame 128, the lay flat angle corresponds to 125 degrees from the base-frame 128 and the in between angle corresponds to any angle between the upright and lay flat angles. For example, in the forward facing direction, the in between angle could be between 105 and 125 degrees. Further, in the forward facing direction, the in between angle could be 115degrees. All rotation functions and angles allow the child seat 100 to comply with the iso box standards. It should be appreciated that the above-described upright angle (e.g., 105 degrees from the base-frame 128) and the lay flat angle (e.g., 125 degrees from the base-frame 128) are exemplary in nature; other angles for each of the upright angle and the lay flat angle are likewise contemplated herein as can be appreciated by one of skill in the art.

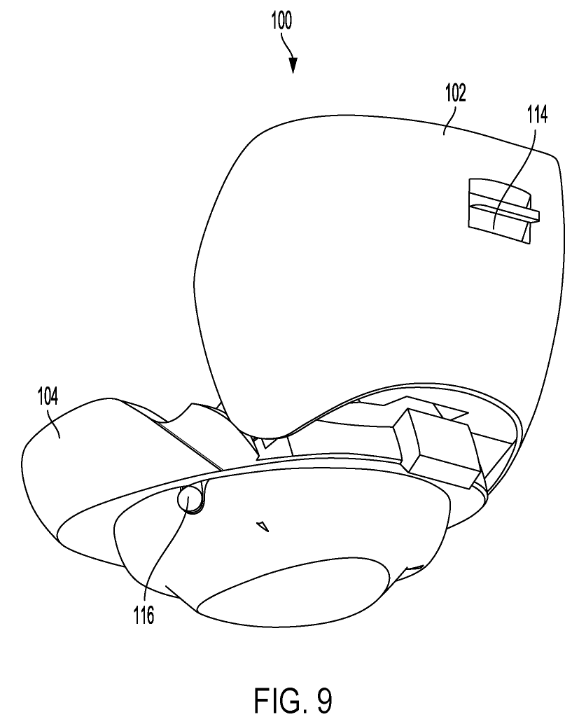

FIG. 9 illustrates a rear perspective view of the child seat 100 in a front facing direction and an upright position. For illustrative purposes, this figure does not contain a base 106. As disclosed here, the child seat 100 comprises a backrest 102 and a lower seat shell 104. The backrest 102 is configured to recline in relation to a pivot point 116. As noted, the child seat 100 also includes a blocker 114, which allows the user to restrict the recline angle of the backrest 102 at a variety of angles including an upright angle, a lay flat angle and an in between angle about a pivot point 116. When the lower seat shell 104 is connected to the ring 100 of the base 106, the pivot point 116 is located inside the base 106. The blocker 114 can be activated. In the activated arrangement, the blocker 114 restricts the backrest 102 of the child seat 100 from reclining. When not in the activated arrangement, the blocker 114 allows the backrest 102 of the child seat 100 to freely recline between a variety of angles. In an illustrative embodiment, the user adjusts the recline angle of the backrest 102 in relation to the base-frame 128 to the preferred angle and then activates the blocker 114 such that the backrest 102 will not move from the preferred angle.

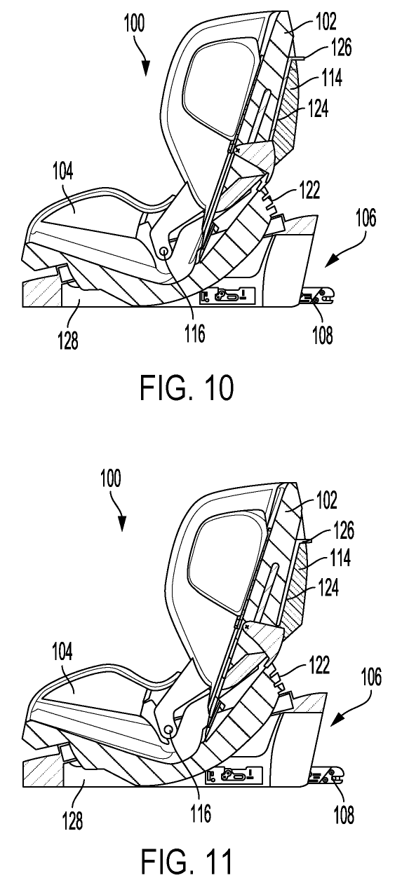

FIG. 10 illustrates a side perspective view of the child seat 100 in a front facing direction, an upright position and a blocker 114 in a not activated arrangement. As shown, the blocker 114 includes a handle 126 fixedly coupled to an insert 124. To allow for the activation of the blocker 114, the lower seat shell 104 includes a volume 122. The volume 122 can be any design that secures the insert such as a plurality of pockets or projections. As an illustrative example, the volume 122 is a plurality of pockets, which correspond to various height positions of the backrest 102. In the activated arrangement, the insert 124 engages a pocket of a plurality of pockets of the volume 122. Each of the plurality of pockets correspond to various height positions of the backrest 102. To adjust the backrest 102, the user pulls the handle 126 away from the volume 122 to disengage the insert 124 from the volume 122 which is disclosed as comprising a plurality of pockets. Once the insert 124 is disengaged from the volume 122, the user can adjust the backrest 102 by allowing the insert 124 of the blocker 114 to engage with, for example, any pocket of the plurality of pockets of the volume 122. To move the blocker to the activated arrangement, the user will grip the handle 126 and apply downwards force on the blocker 114 such that the blocker 114 engages with the volume 122. As disclosed in FIG. 10, the blocker 114 is not activated because the insert 124 of the blocker 114 is not engaged with the volume 122, which is disclosed as a plurality of pockets. Conversely, FIG. 11 discloses the blocker 114 in an activated arrangement. In the activated arrangement, the insert 124 of the blocker 114 is engaged in a pocked of the volume 122, which is disclosed as a plurality of pockets.

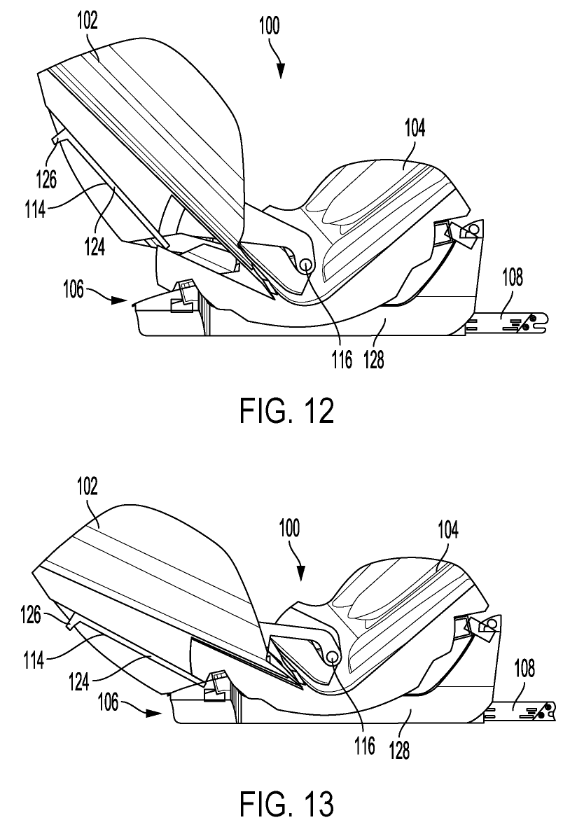

FIG. 12 illustrates a side perspective view of the child seat 100 in a rear facing configuration, an upright position and a blocker 114 that is activated. As previously noted, the backrest 102 of the child seat 100 can recline at a variety of angles about a pivot point 116. The pivot point 116 sits at the occupant’s hip flexion point. The backrest 102 further comprises the blocker 114, which includes a handle 126 fixedly coupled to an insert 124. To allow for the activation of the blocker 114, the lower seat shell 104 includes a volume 122. Thus, FIG. 12 discloses the insert 124 of the blocker 114 engaged with the volume 122. In this illustrative example, the user cannot manipulate the angle of the backrest 102 due to activation of the blocker 114.

FIG. 13 illustrates a side perspective view of an example child seat 100 in a rear facing direction, a lay flat position and a blocker 114 that is activated. Similar to FIG. 12, the insert 124 of the blocker 114 is engaged with the volume 122. In this illustrative example, the user cannot manipulate the angle of the backrest 102 due to activation of the blocker 114. However, in FIG. 13, the user has reclined the backrest 102 to the lay flat position such that the occupant will be reclined at a larger angle relative to the base-frame 128 in comparison to the upright position.

In various embodiments, the child seat 100 is symmetrical. For example, FIG. 9 discloses back peripheral view of the child seat 100 including the backrest 102, the lower seat shell 104, the blocker 114 and the pivot point 116. It can be understood that the opposing side, although not disclosed, includes the same features as the disclosed side of the child seat. Should the child seat 100 include additional features not disclosed, the features can be duplicated on the opposing side.

It should be appreciated that the variety of recline angles and rotation directions the child seat 100 and base 106 in combination can achieve contribute to enhanced capabilities of the child seat 100. For example, the child seat 100 can be manipulated such that the child seat 100 can adapt to occupants of varying sizes all while complying with the iso box standard. Recline angles and rotation directions can be varied as can be appreciated by one of skill in the art.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A child seat system configured to be secured to a car seat, the system comprising a child seat, which comprises:
a backrest;
a lower seat shell, wherein the backrest can recline relative to a pivot point between an upright position, a lay flat position, and one or more in between positions;
a base, wherein the base is configured to receive the lower seat shell; and
a blocker, wherein the blocker is adjustable between an activated position and a not activated position, wherein, in the activated position, the blocker prevents the backrest from reclining, and wherein, in the not activated position, the blocker does not prevent the backrest from reclining.

2. The system of claim 1, wherein the base comprises:
a base-frame;
ISOFIX arms connected to the base-frame; and
a ring positioned at an angle relative to the base-frame.

3. The system of claim 2, wherein the ring comprises:
an outer ring; and
an inner ring.

4. The system of claim 3, wherein the outer ring includes at least one notch.

5. The system of claim 4, wherein the lower seat shell includes at least one protrusion wherein the at least one protrusion is configured to engage the at least one notch when the child seat is in a side facing direction.

6. The system of claim 2, wherein the base comprises a rebound bar, and wherein the ring is connected to the base-frame and the rebound bar.

7. The system of claim 6, wherein the rebound bar is connected to the ring and the base-frame.

8. The system of claim 7, wherein the base comprises:
a first bar positioned between the ring and the rebound bar; and
a second bar positioned between the ring and the base-frame.

9. The system of claim 1, wherein the pivot point is located inside the base.

10. The system of claim 1, wherein the base is configured to receive a seat belt, and the base is fixed to the car seat.

11. The system of claim 2, wherein the angle is 13 degrees.

12. The system of claim 1, wherein the blocker comprises:
a handle fixedly coupled to an insert located on the backrest; and
a volume located on the lower seat shell, wherein the volume is configured to receive the insert.

13. The system of claim 12, wherein the blocker is in the activated position when the insert is engaged with the volume and wherein the blocker is in the not activated position when the insert is disengaged from the volume.

14. The system of claim 12, wherein the volume is a plurality of pockets.

15. A child seat configured to be secured to a car seat, the child seat comprising:
a backrest and a lower seat shell, wherein the backrest can recline relative to a pivot point between an upright position, a lay flat position, and one or more in between positions; and
a blocker, wherein the blocker is adjustable between an activated position and a not activated position, wherein, in the activated position, the blocker prevents the backrest from reclining, and wherein, in the not activated position, the blocker does not prevent the backrest from reclining.

16. The child seat of claim 15, wherein the lower seat shell comprises a at least one protrusion.

17. A method of securing a child seat to a car seat comprising:
placing the child seat of claim 16 onto a base.

18. The method of claim 17, wherein the base comprises:
a base-frame;
ISOFIX arms;
a ring; and
a rebound bar.

19. The method of claim 17, wherein the ring comprises:
an outer ring with at least one notch, wherein the at least one protrusion is configured to engage the at least one notch; and
an inner ring.

20. The method of claim 19, wherein the method includes aligning the least one protrusion with the at least one notch when the child seat is in a side facing direction and twisting the child seat to a front facing or a rear facing direction.
